(19) United States
(12) Patent Application Publication
(10) Pub. No.: US 2005/0055555 A1
(43) Pub. Date: Mar. 10, 2005

(54) Single sign-on authentication system

(76) Inventors: Srinivasan N. Rao, Newark, NJ (US); Lioun Chen, Edison, NJ (US); Bruce Skingle, Hardwick (GB)

Correspondence Address: GEORGE MORGAN;LOWENSTEIN SANDLER, PC, 65 LIVINGSTON AVENUE, ROSELAND, NJ, 07068, US

(21) Appl. No.: 10/721,063

(22) Filed: Nov. 24, 2003

Related U.S. Application Data
(60) Provisional application No. 60/500,391, filed on Sep. 5, 2003.

(51) Int. Cl. H04K 1/00

(52) U.S. Cl. 713/182

(57) ABSTRACT

A single sign-on authentication system includes an authentication component that determines whether a user is authenticated, and, if it is determined that the user is authenticated, generates a connection request, the connection request including an identifier and entitlement information. The system also includes an interface component that receives the connection request from the authentication component. The interface component compares the received identifier with an expected identifier. If they match, the interface component makes the entitlement information available to a server associated with the interface component. A method for enabling an authenticated user to connect to a server in a computer network includes receiving a connection request for an authenticated user, the connection request including an identifier and entitlement information; comparing the received identifier with an expected identifier; and, if they match, making the entitlement information available to the server.

### CROSS REFERENCE TO RELATED APPLICATIONS

This application claims the benefit of U.S. Provisional Application Ser. No. 60/500,391, filed by Rao et al. on Sep. 5, 2003 and entitled “Single Sign-On Authentication System”, which is incorporated herein by reference.

### FIELD OF THE INVENTION

The present invention relates generally to computer network security, and, more particularly, to a system and a method for enabling a secure single sign-on to a computer network.

### BACKGROUND OF THE INVENTION

Currently, many companies employ computer networks that require users to separately sign-on to individual systems. For instance, a user may be required to sign-on to one computer system in order to access a spreadsheet application and then to another to access an e-mail application. Very often, users are prompted for a different user id and password during each sign on. The user must then remember several different user id's and passwords.

In an attempt to deal with this problem, some vendors offer single sign-on (SSO) capability. However, conventional SSO systems typically entail complex authentication schemes. For example, U.S. Pat. No. 5,684,950 to Dare et al., entitled “Method and System for Authenticating Users to Multiple Computer Servers Via a Single Sign-On,” discloses a method for authenticating a user to multiple computer servers. The method involves an authentication broker which receives an authentication request. The authentication broker then validates the request and issues a token. Once the user's workstation has received the token from the authentication broker, it then sends the token to the server that it wishes to interact with, to indicate that it has been authenticated.

Although useful, SSO schemes such as the one described above involve a significant amount of overhead. Accordingly, improved SSO systems and methods are needed.

### SUMMARY OF THE INVENTION

The present invention provides a technique for enabling a secure, single sign-on to a computer network that requires comparatively less complexity and overhead than conventional single sign-on methods.

A single sign-on authentication system includes an authentication component that determines whether a user is authenticated, and, if it is determined that the user is authenticated, generates a connection request, the connection request including an identifier and entitlement information. The system also includes an interface component that receives the connection request from the authentication component. The interface component compares the received identifier with an expected identifier. If they match, the interface component makes the entitlement information available to a server associated with the interface component.

A method for enabling an authenticated user to connect to a server in a computer network includes receiving a connection request for an authenticated user, the connection request including an identifier and entitlement information; comparing the received identifier with an expected identifier; and, if they match, making the entitlement information available to the server.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram showing an exemplary single sign-on authentication system; and

FIG. 2 shows a flow diagram outlining an exemplary technique for processing a connection request.

### DESCRIPTION OF PREFERRED EMBODIMENTS

The present invention takes advantage of the notion that once a user has successfully signed on to a network, any computer system in the network receiving a connection request need only verify that the connection request was received from the network's sign-on component. If the connection request originated with the sign-on component, then there is no need to again query the user for authentication information and to authenticate the user.

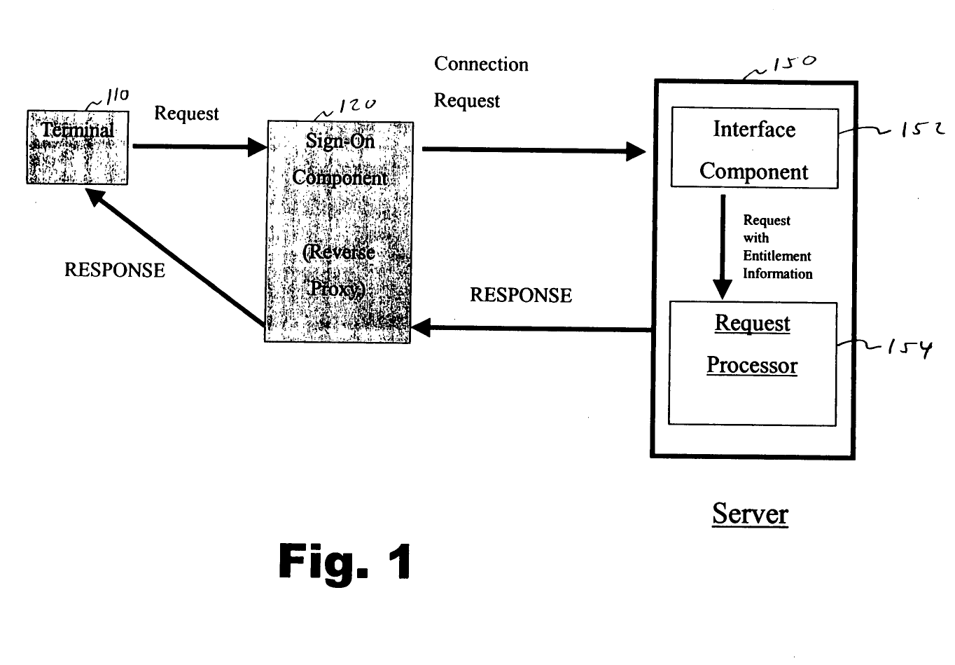

FIG. 1 is a block diagram of an exemplary single sign-on authentication system 100. The single sign-on authentication system 100 includes a terminal 110, a sign-on component 120, and a server 150. The server 150 includes an interface component 152 and a request processor 154. While this system 100 includes a single terminal 110 and a single server 150, it is to be appreciated that typically there would be numerous other terminals and servers connected to the sign-on component 150.

In operation, a user interacting with the terminal 110 is presented with a sign-on screen (not shown). The user then enters authentication information using this screen. The entered authentication information is then transmitted to the sign-on component 120. In general, authentication information includes any information used to verify a person's identity to ensure that the person has access to a particular computer network. Commonly, authentication information includes a unique identifier and a password. In an alternative embodiment, the terminal 110 includes a biometric device (e.g., fingerprint reader, retina scan) which may instead, or in addition, be used to verify the user's identity.

Once the authentication information is received by the sign-on component 120, it can be used to determine whether the user is authorized to use the network. This can be done, for example, by comparing the received authentication information with information on file regarding valid users.

After the user is authenticated, the sign-on component 120 preferably determines which systems in the network the user may access. The user might be prompted to select which of the systems to access. Alternatively, the selection process could be accomplished automatically (e.g., via a script). The sign-on component 120 also preferably determines the entitlement information needed by each of the individual systems that the user will access. In general, entitlement information includes information used by an individual computer system to assign system resources and/or establish user preferences. The sign-on component 120 then issues several connection requests, each to connect to one of the selected systems.

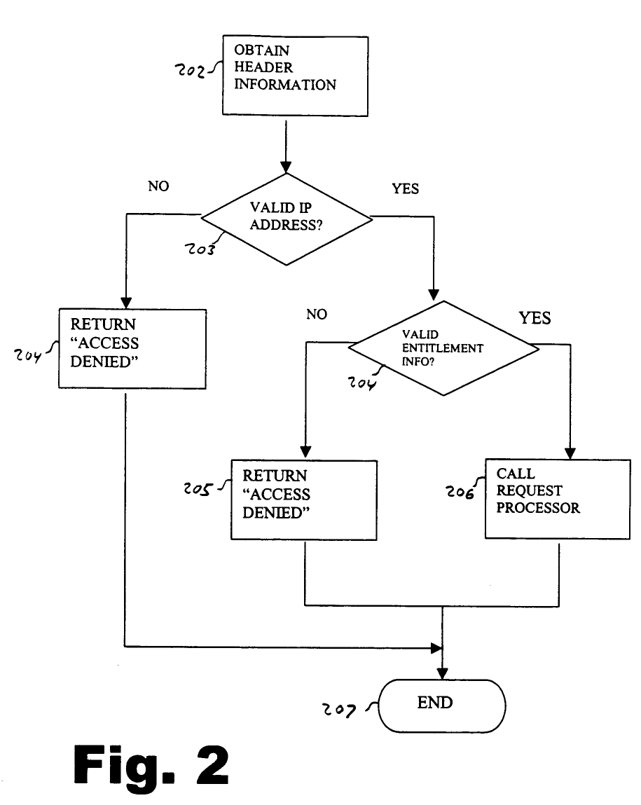

FIG. 2 is an exemplary flow diagram outlining an exemplary technique for processing a connection request.

In step 202, header information from the connection request is obtained. This header information will generally include a source identifier and entitlement information. Assuming that the connection request is an HTTP request, the source identifier will include an Internet Protocol (IP) address. In general, an IP address is a 32-bit binary number that uniquely identifies a host (computer) connected to the Internet, for the purpose of communication through the transfer of packets. The use of IP addresses is part of the standard transmission control protocol/Internet protocol (TCP/IP).

Next, in step 203, a determination is made as to whether the IP address is valid. Since the sign-on component 120 will have a known IP address, verification of the IP address can be accomplished by simply comparing the obtained IP address against the known IP address of the sign-on component 120. If the IP address cannot be verified (i.e., it doesn't match), control passes to step 204, where a message indicating an invalid connection is returned; otherwise, control passes to step 204.

In step 204, a determination is made as to whether the entitlement information is in the correct format. If this information is not in the proper format (or isn't present), control passes to step 205, where a message indicating an invalid connection is returned; otherwise, control passes to step 206. (The format of the entitlement information will vary depending on the particular application. For example, if the information includes the user's e-mail address, the format could be xxxxx@xxxxx.com).

In step 206, the request processor 154 is called. When the request processor 154 is called, the entitlement information (e.g., e-mail address) can be used to establish access to the system. The request processor assigns resources and/or preferences using the entitlement information. Once access has been established, the user may thereupon directly connect to the server 150. The process terminates in step 207.

It is be understood that the method outlined above an be implemented in various forms of hardware, software, firmware, special purpose processors, or a combination thereof. Preferably, the present invention is implemented in software as a program tangibly embodied on a program storage device.

It is also to be understood that, because some of the constituent system components and method steps depicted in the accompanying figures are preferably implemented in software, the actual connections between the system components (or the process steps) may differ depending upon the manner in which the present invention is programmed.

The invention will be further clarified by the following example:

### Example 1

A user accesses a corporate intranet using a personal computer. The user's computer employs the Microsoft Windows operating system, and includes the Internet Explorer browser. The user must enter a unique identifier and a password to sign on.

The user has access to a Lotus Notes e-mail system running on a Domino Server, securely maintained in the same facility as the sign-on system. The “interface component” is a Domino System Application Program Interface (DSAPI) plug-in module. The DSAPI plug-in module is maintained on a DSAPI library.

In operation, the user connects to the corporate intranet using the browser. The user then is queried for his user identifier and password. The user enters this information into the screen. The entered information is then transmitted to the sign-on component, where it is validated. The sign-on component then searches for systems that the user is entitled to access. It is determined that the user has access to the Lotus Notes e-mail system. The sign-on component then consults a cross-reference file, and finds the user's Lotus Notes e-mail address. The sign-on component calls the Domino Server. When the Domino Server is initially called, it invokes the DSAPI plug-in module. The module checks the IP address of the request packet to make sure that it matches the expected address. Assuming it matches, the module then formats a Common Name (CN) data structure with the e-mail address (and other information). The Domino Request Processor then uses the Domino-CN, to provide the user with appropriate access.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A single sign-on authentication system, comprising:
an authentication component that determines whether a user is authenticated, and, if it is determined that the user is authenticated, generates a connection request;
an interface component that receives the connection request from the authentication component, the connection request including an identifier and entitlement information; wherein the interface component compares the received identifier with an expected identifier and, if they match, makes the entitlement information available to a server associated with the interface component.

2. The single sign-on authentication system of claim 1, wherein the entitlement information is different from information used to authenticate the user.

3. The single sign-on authentication system of claim 1, wherein the identifier includes an Internet Protocol (IP) address.

4. The single sign-on authentication system of claim 2, wherein the authentication component determines the entitlement information based on the information used to authenticate the user.

5. The single sign-on authentication system of claim 4, wherein the information used to authenticate the user includes one or more of a user identifier and a password.

6. The single sign-on authentication system of claim 1, wherein the entitlement information is contained in a header portion of a data packet.

7. The single sign-on authentication system of claim 1, wherein the connection request is sent as an HTTP request.

8. A method for enabling an authenticated user to connect to a server in a computer network, comprising:
receiving a connection request for the authenticated user, the connection request including an identifier and entitlement information;
comparing the received identifier with an expected identifier; and
making the entitlement information available to the server, only if the result of the comparison is a match.

9. The method of claim 8, wherein the entitlement information is different from information used to authenticate the authenticated user.

10. The method of claim 8, wherein the received identifier includes an Internet Protocol (IP) address.

11. The method of claim 9, wherein the entitlement information is determined based on the information used to authenticate the user.

12. The method of claim 11, wherein the information used to authenticate the authenticated user includes one or more of a user identifier and a password.

13. The method of claim 8, wherein the entitlement information is contained in a header portion of a data packet.

14. The method of claim 8, wherein the connection request is sent as an HTTP request.

15. A program storage device readable by a machine, tangibly embodying a program of instructions executable on the machine to perform method steps for enabling an authenticated user to connect to a server in a computer network, the method steps comprising:
receiving a connection request for the authenticated user, the connection request including an identifier and entitlement information;
comparing the received identifier with an expected identifier; and
making the entitlement information available to the server, only if the result of the comparison is a match.
